(19) United States
(12) Patent Application Publication
(10) Pub. No.: US 2003/0191780 A1
(43) Pub. Date: Oct. 9, 2003

(54) Computer system and method for the search statistical evaluation and analysis of documents

(76) Inventors: Georg Heger, Krefeld (DE); Ralf Pakull, Pulheim (DE); Christoph Schaub, Koln (DE)

Correspondence Address: BAYER POLYMERS LLC, 100 BAYER ROAD, PITTSBURGH, PA, 15205, US

(21) Appl. No.: 10/406,816

(22) Filed: Apr. 4, 2003

(30) Foreign Application Priority Data
Apr. 9, 2002 (DE) 10215495.3

(51) Int. Cl. G06F 17/00

(52) U.S. Cl. 707/104.1

(57) ABSTRACT

The present invention relates to a computer system for the search, statistical evaluation and analysis of documents, with a server computer with means of access to an external database over a computer network, means for querying the external database according to a standard search profile, means for starting the query at predefined time intervals and means for storing data from the external database as the result of the query for an internal database. The present invention also includes a a client computer with first program means for input of an individual search request for a search in the internal database, second program means for display of a hit list from the search, third program means for selection of data from the hit list by a user, means for loading and storing the selected data from the internal database, fourth program means for the display of stored data, fifth program means for the statistical evaluation of stored data, sixth program means for the analysis of stored data and means for selection of the display, statistical evaluation or analysis of stored data.

### FIELD OF THE INVENTION

The present invention relates to a computer system for the search, statistical evaluation and analysis of documents, such as technical documents and patent literature. The invention further relates to a corresponding method and computer program.

### BACKGROUND OF THE INVENTION

Various systems for document management and the analysis of technical literature and patents are known.

U.S. Pat. No. 5,991,751 discloses a system which is based on patent databases and further databases with information that is of interest for a firm. In the system, various groups are formed, each group containing a number of patents of the patent database. In response to a suitable command, the patents belonging to a group are processed in conjunction with the information of the further databases. It is also possible, for instance, to ascertain patent citations, the number of patents of an inventor, and similar information automatically.

A relational database that contains a multidimensional hierarchical model of interconnected categories is disclosed in U.S. Pat. No. 5,721,910. The database can be used to record the significant content of scientific or technical documents, such as patents or patent abstracts, and to classify the documents into a particular scientific or technical category in the multidimensional hierarchical model.

A system for the management and analysis of documents is disclosed in U.S. Pat. No. 6,038,561. The system is interactive and allows both word-based analysis and also a conceptual analysis as well as the display of information. A particular application area is the analysis of patent literature, such as patent claims, for example.

A system for so-called Intellectual Property Asset Management is taught in WO 00/52618. In the system, data from different databases is merged, and citations and inventors' details are evaluated.

U.S. Pat. No. 5,999,907 teaches an examination system for intellectual property, which is used for assessment of a portfolio. The system contains a database, which holds information concerning a portfolio of industrial protective rights. The system contains further databases for storing empirical data for assessment of the portfolio. This involves the determination of qualitative ratios, which are calibrated on the basis of economic values.

U.S. Pat. No. 6,014,663 discloses a system for analysis of a document, which verifies the consistent use of the terminology in a patent application.

U.S. Pat. No. 5,991,780 teaches a system for selective display of patent texts and drawings. The text and the drawings are stored in files separated from each other, and presented together in a user interface.

Further systems for processing and displaying patent documents are disclosed in U.S. Pat. Nos. 5,950,214, and 6,018,749 and WO 00/11575.

Methods for patent analysis are also disclosed in European patent application number 001 18 457, as well as from K K Brockhoff: “Indicators of Firm Patent Activities”, Portland, Oct. 27-31, 1991, New York, IEEE, US, vol.—October 1991 (1991-10), pages 476-481, XP002923550 and V Stefanov: “Some Possibilities of a Patents Database in Determining a Firm's Policy”, World Patent Information, GB, Elsevier Sciences Publishing, Barking, Vol 17, no. 3, Sep. 1, 1995 (1995-09-01), pages 201-204, XP004037786, ISSN: 0172-2190.

An object of the present invention is to create an improved computer system for the search, statistical evaluation and analysis of documents, especially of technical documents and patent literature, as well as a corresponding method and computer program product.

### SUMMARY OF THE INVENTION

The present invention allows an integrated corporate system to be created for access to technical and patent information, and for evaluation and analysis of the information, especially for the purpose of competition monitoring and intellectual property management. The invention allows selective acquisition of documents, for example by means of a profile search in patent databases, the search being performed at regular intervals, such as daily, weekly or monthly. The relevant documents are then saved and distributed within the company. It is also possible to search in the company's internal database and to load the investigated documents.

The present invention also includes the statistical evaluation of the documents found, according to predefined categories, such as automatic generation of bar charts to represent the distribution of patents to competitors or technology fields, or other categories.

The present invention further allows analysis of documents in the company's internal database by means of patent analysis functions which are known per se.

### DETAILED DESCRIPTION OF THE DRAWINGS

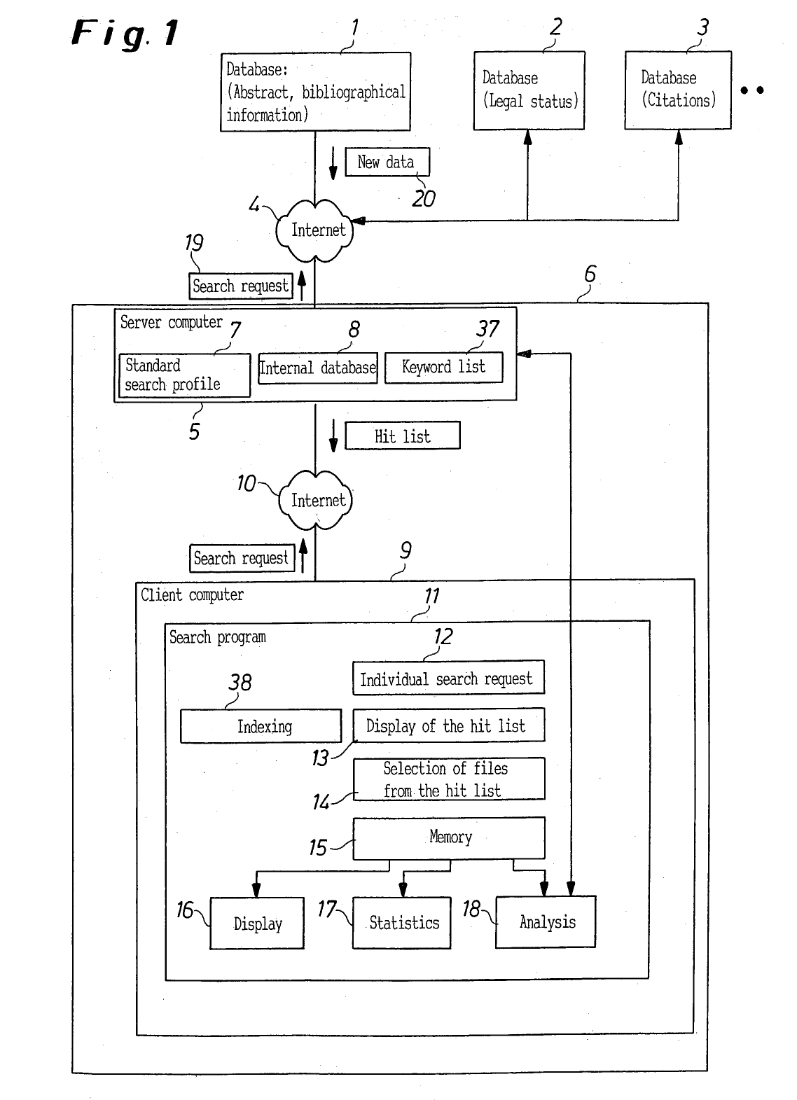

FIG. 1 is a block diagram of a computer system according to the present invention.

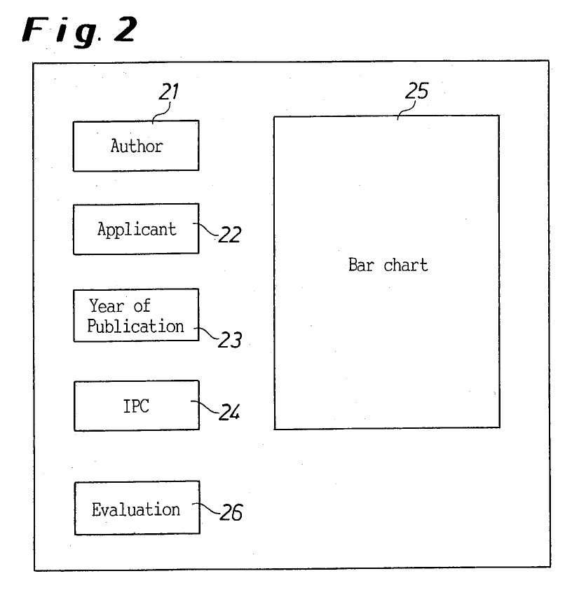

FIG. 2 is a graphic user interface for the statistical evaluation of the documents according to the present invention.

FIG. 3 is a flowchart to represent database server and server client processes.

### DETAILED DESCRIPTION OF THE INVENTION

According to the present invention, control elements are displayed in a graphic user interface, each of the control elements corresponding to a certain category, for which a statistical evaluation can be performed. Examples of control element categories offered to the user include “Author”, “Applicant”, “Year of Publication” or “International Patent Class (I PC)”. When the user selects one of these control elements, e.g. by clicking on it with the mouse, a corresponding statistical analysis of the documents is automatically performed. The result of the analysis is preferably output in the form of a bar chart or as a 2D matrix.

The user preferably begins this process by performing a search in the internal company database for patent documents of interest to him. The user receives a hit list of documents as the result. From this hit list, the user typically selects all documents or a subset, for further evaluation. For the subsequent evaluation of the selected documents from the hit list, the graphic user interface with the control elements offers a convenient platform, which the user can use intuitively without a long period of familiarization.

According to the present invention, the user has the possibility of analysis of the selected documents in the hit list in addition to the statistical evaluation. For this, quality coefficients are automatically calculated as is disclosed in European patent application EP 1 182 578 A1. The quality coefficients can be, for example, patent quality ratios.

According to the present invention, the external database contains the abstracts and bibliographical information of patents. This database is searched within predefined time intervals, daily for instance, with a defined standard search profile.

The newly acquired documents are then loaded on the company's internal server computers and saved in an internal database. However, further data such as legal status information and citations is needed for calculating quality coefficients for patent analysis. This data is retrieved from an external data source as necessary, if a user wishes for an analysis of this nature. Preferably, the query for supplementary data can occur automatically. A further advantage is that data, such as, legal status information and citations that is only of interest in special cases is not loaded in advance for all patents, so that there can be a saving in memory space and database costs. However, if data that is no longer changing is found among the data that is only of interest in special cases, it is stored in the internal databases. This applies especially to legal statuses.

According to the present invention, the result of the analysis is graphically formatted and output in an intuitive form. A preferred form of output is known per se and is disclosed in European patent application EP 1 182 578 A1.

The computer system of according to the present invention has an external database 1, which for example is a database for storing technical and/or patent literature. For each document entered in the database 1, there is a data record, which contains an abstract and bibliographical information for the relevant document.

In addition, it is also possible to access further external databases, for example database 2 and database 3, which contain supplementary information, needed for calculating documents' quality coefficients, for the documents of the database 1. In the case of patent literature, this further information can be legal status information and/or citations, for example.

The databases 1, 2 and 3 can e.g. be accessed over the Internet 4 or Datex P from the server computer 5 of an organization 6. A standard search profile 7 is stored in the server computer 5. The standard search profile 7 is automatically started at certain time intervals, for example once daily or at other regular or irregular intervals. A search request is defined in the standard search profile 7, covering topic areas relevant for the organization 6.

The data records found as a result of the standard search profile 7 are stored in an internal database 8 on the server computer 5. A keyword list 37 is also stored on the server computer 5.

The keyword list 37 contains a predefined set of keywords, which can be used for indexing documents. The keywords in the keyword list 37 are chosen here according to the fields of interest of the organization. One or more synonymous terms can be assigned to each of these preset keywords, as can translations into other languages. This means that documents using different terminology or documents in a foreign language can also be indexed.

From a client computer 9, the server computer 5 and its internal database 8 can be accessed via an intranet 10. Typically, several employees of the firm 6 have such a client computer 9 with the possibility of accessing the server computer 5 via the intranet 10.

The client computer 9 contains a search program 11 with a program module 12 for an individual search request. The program module 12 can contain a customary Internet browser such as Microsoft Explorer or Netscape Navigator, for example. Via this Internet browser, the user of the client computer 9 makes contact with the server computer 5, by entering the Uniform Resource Locator (URL) of the desired web site of the server computer 5 in the browser program. The individual search request or a stored search request can be entered in this web site.

The search program 11 further contains a program module 13 for the display of the hit list obtained for an individual search request. This display can also take place via the web browser.

The search program 11 further contains a program module 14 for the selection of data records from this hit list. The selection of data records from the hit list can also be implemented by means of the web browser. The data records selected by the user from the hit list are then automatically loaded from the server computer 5, i.e. its internal database 8, on to the client computer 9, and stored in its memory 15.

The keyword list 37 is preferably also transferred to the client computer, or its search program 11, along with the hit list. The search program 11 has a program module 38 for indexing the data of the hit list with the help of the keyword list 37. The keywords assigned to the individual documents of the hit list are transferred by the search program 11 via the intranet 10 to the server computer 5 and stored there in the internal database 8.

By this means, a different user accessing the relevant documents at a later date can use the previously executed indexing again. With the keyword list 37, it is preferred that terminology consistent throughout the organization is used for the keywords and also for search requests. Search requests are preferably constructed from the defined keywords in the keyword list 37.

The keywords determined for a particular hit list are similarly stored together with the data of the hit list in the memory 15.

The data records stored in the memory 15 can then be accessed for various purposes, such as for the display of data, its statistical evaluation and/or its analysis.

For this the search program 11 contains a program module 16 for the display of data records stored in memory 15, and a program module 17 for the statistical evaluation. A program module 18 also serves for analyzing the stored documents. Quality coefficients, which need further supplementary data, are calculated for this analysis. In this case the program module 18 automatically accesses the database 2 through the server computer 5 and e.g. the Internet 4, to retrieve the supplementary data.

Thus in the operation of the system in FIG. 1, the standard search profile 7 is processed once daily, for instance, and a corresponding search request 19 is directed to the database 1. The system then responds with new data 20, which has been acquired since the last query and matches the interest profile for the organization 6, as formulated in the search request 19.

The new data 20 is stored in the internal database 8, and optionally indexed, e.g. by one skilled in the art, according to a scheme adapted for the organization.

An employee of the organization 6 can then use his client computer 9 to input an individually formulated search request and direct it to the internal database 8. A hit list is then displayed for the user on his screen, and all the data or a subset of the data can be selected from this list. The selected data is then loaded from the internal database 8 into the memory 15 of the client computer 9, so that the user can process it further. One possibility for the user is to present the loaded data graphically by means of the program module 16, i.e. to open and display the file. A further possibility is statistical evaluation using the program module 17, and also patent analysis using the program module 18.

FIG. 2 shows the user interface for the program module 17. The user interface contains the control elements 21, 22, 23 and 24 for the categories “Author”, “Applicant”, “Year of Publication” and “IPC”. If a user selects the control element 22, for example, a bar chart is automatically output in the display area 25 on the screen, showing the number of documents per patent applicant in the selected set of data from the hit list. The action is similar for the other available categories. An advantage of the present invention is that the user has no need to formulate statistical evaluations himself, but simply clicks on the desired category.

The user can start the program module 18 for the statistical evaluation by selecting the control element 26. The evaluation is then automatically performed, and likewise output in graphic form, for the data previously selected from the hit list and stored. For this the program module 18 automatically accesses the external database 2 if necessary, to retrieve supplementary information from it.

FIG. 3 shows a flowchart of the corresponding processes. The process 27 here relates to the process in which the database 1 and the server computer 5 are involved. This process 27 consists of the step 28, in which the server computer processes the standard search profile and directs a corresponding search request to the database. In the step 29, corresponding new documents are delivered to the server computer from the database, and stored in the server computer's internal database.

Process 30, which concerns one of the client computers and the server computer, runs in parallel to and independently of this. Several such processes 30 can run in parallel for different client computers.

The user begins by entering his individual search request in step 31. He receives a hit list for this in step 32.

The user then has the option of selecting elements of the hit list for display in step 33 or for statistical evaluation in step 34. The user has the further possibility of an analysis. For this it is possible in some circumstances that supplementary data is loaded in step 35, for performing this analysis in step 36.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A computer system for the search, statistical evaluation and analysis of documents comprising:
(a) a means for accessing at least one external database through a computer network,
(b) a means for querying the external database according to a standard search profile,
(c) a means for performing the query at a predefined time interval,
(d) a means for storing data from the query on an internal database,
(e) a means for requesting an individual search of the internal database,
(f) a means for displaying the results of the individual search in the form of a hit list,
(g) a means for selecting data from the hit list,
(h) a means for storing the selected data,
(i) a means for displaying the selected data,
(j) a means for statistically evaluating the selected data or analyzing the selected data, and
(k) a means for displaying the evaluated or analyzed data.

2. The computer system according to claim 1, wherein the means for statistical evaluation has means of determining an absolute or relative frequency of instances of a category in the selected data.

3. The computer system according to claim 2, wherein the means for statistical evaluation has a means of displaying control elements on a graphic user interface, wherein each control element is assigned to a category.

4. The computer system according to claim 3, wherein the means for the statistical evaluation has a means of generating a bar chart for a selected category.

5. The computer system according to claim 1, further comprising a means for accessing a second external database that contains information needed for calculating a quality coefficient(s).

6. The computer system according to claim 5, wherein the means for analyzing the selected data has a means of calculating the quality coefficient(s).

7. The computer system according to claim 5, further comprising a means for graphically outputting analyzed selected data.

8. The computer system according to claim 1, wherein a first external database is a database for storage of abstracts and bibliographical information of patent documents.

9. The computer system according to claim 5, wherein the second external database contains legal status information and citation of the patent documents.

10. The computer system according to claim 5, wherein in the quality coefficient(s) is an indicator of patent activities.

11. The computer system according to claim 1, wherein the computer system comprises a server computer for communication with at least one external database via the Internet and for communication with a client computer via the Intranet.

12. The computer system according to claim 11, wherein the server computer has a means for storing keywords and the client computer has a means for indexing data from the hit list by means of the keyword list.

13. A method for the computer-supported search, statistical evaluation and analysis of documents comprising:
(a) accessing at least one external database over a computer network,
(b) querying the external database according to a standard search profile at predefined time intervals,
(c) storing data from the external database as a result of the query on an internal database,
(d) inputting an individual search request for a search in the internal database by a client computer,
(e) displaying a hit list from the search,
(f) selecting data from the hit list,
(g) loading the selected data from the internal database,
(g) storing the loaded data on the client computer,
(h) inputting a request for the display, statistical evaluation or analysis of the stored data, and
(i) displaying, statistically evaluating or analyzing the selected data.

14. The method according to claim 13, wherein the statistical evaluation determines absolute or relative frequency of an instance of a category from the stored data being selected.

15. The method according to claim 14, further comprising displaying control elements on a graphic user interface, wherein each control element is assigned to a category, and the stored data being used for the automatic determination of the absolute or relative frequencies of the instances of a category is chosen by selection of one of the control elements.

16. The method according to claim 13, further comprising automatically outputting the result of the statistical evaluation in the form of a bar chart.

17. The method according to claim 13, further comprising automatically accessing a second external database and calculating a quality coefficient(s), wherein the second external database contains information needed to calculate the quality coefficient.

18. The method according to claim 17, further comprising outputting results of the analysis in graphic form.

19. The method according to claim 13, wherein a first external database contains abstracts and bibliographical information of patent documents.

20. The method according to claim 17, wherein the second external database contains legal status information and citations of the patent documents.

21. The method according to claim 13, further comprising transferring keywords to a client computer together with the selected data and then indexing the selected data by the keywords.

22. A computer program product on a computer server with a program means for carrying out a method for the computer-supported search, statistical evaluation and analysis of documents comprising:
(a) accessing at least one external database over a computer network,
(b) querying the external database according to a standard search profile at predefined time intervals,
(c) storing data from the external database as a result of the query on an internal database,
(d) inputting an individual search request for a search in the internal database by a client computer,
(e) displaying a hit list from the search,
(f) selecting data from the hit list,
(g) loading the selected data from the internal database,
(h) storing the loaded data on the client computer,
(i) inputting a request for the display, statistical evaluation or analysis of the stored data, and
(j) displaying, statistically evaluating or analyzing the selected data.
